(19) United States
(12) Patent Application Publication
(10) Pub. No.: US 2005/0041111 A1
(43) Pub. Date: Feb. 24, 2005

(54) Frame adjustment device and image-taking device and printing device

(76) Inventor: Miki Matsuoka, Kyoto-shi (JP)

Correspondence Address: OSHA & MAY L.L.P., 1221 MCKINNEY STREET, HOUSTON, TX, 77010, US

(21) Appl. No.: 10/902,496

(22) Filed: Jul. 29, 2004

(30) Foreign Application Priority Data
Jul. 31, 2003 (JP) 2003-204469

(51) Int. Cl. H04N 5/225

(52) U.S. Cl. 348/207.99

(57) ABSTRACT

A face of an object can be easily or automatically set in a frame at the time of shooting. A frame adjustment device determines whether the face of the object is included in the frame or not by detecting a characteristic point from an image taken preliminarily. Then, the frame adjustment device determines whether the face protrudes from the frame or not based on the characteristic point. When the face of the object protrudes from the frame, the frame adjustment device acquires an adjustment amount of the frame based on the position of the detected characteristic point or the position of the face.

### BACKGROUND OF THE INVENTION

1. Field of the Invention

The present invention relates to technique which is effectively applied to an image-taking device for taking an image in which especially a person is an object and a printing device for printing an image in which a person is an object.

2. Description of the Background Art

When an image including a person as an object is to be taken, a position of a frame of the image or a zoom is adjusted based on the person of the object in many cases.

For example, there is technique in which an area of an object in an image is kept constant by automatically controlling a zoom. More specifically, the object is detected from the image and the area of the detected object is calculated. Thus, a zoom motor 12 is controlled so that the calculated object area may be in a constant range with respect to an area of the object at the time of initial setting (refer to Japanese Unexamined Patent Publication No. 09-65197).

In addition, as another example, there is technique which is designed to automatically perform cropping or focusing or focusing on a photograph based on a main object in an image (refer to Japanese Unexamined Patent Publication No. 2001-236497). Here, “cropping” means that the image in a specific frame is cut out from the image.

In addition, as another example, there is technique in which distances between an object and a center and upper parts of a shooting screen are measured and when the distances are almost the same, it is determined that the object protrudes from the frame and then the shooting operation is prohibited and/or a warning is generated (refer to Japanese Patent Publication No. 297793).

In an image in which a person is an object, as one undesirable situation for a user, there is a situation in which a face of the object protrudes from a frame of the image taken. Therefore, it is required that such situation can be automatically avoided. However, this problem is not solved by the conventional technique.

For example, there is technique in which a zoom is automatically adjusted depending on an area of the object like Japanese Unexamined Patent Publication No. 09-65197. However, by this technique, it cannot be determined whether the object protrudes from the frame or not. More specifically, since the area of the object varies with a distance between an image-taking device and the object, even if the object protrudes from the frame, the area is determined to be large when the distance between them is close. Meanwhile, even when the object is set in the frame, if the distance is large, the area is determined to be small.

In addition, if the image is taken when the face of the object protrudes from the frame, it is basically impossible to add the image of a protruding part of the face by a subsequent image processing and the like. That is, to take the object which does not protrude from the frame is a subject before cropping as disclosed in Japanese Unexamined Patent Publication No. 2001-236497.

Thus, the technique disclosed in Japanese Unexamined Patent Publication No. 09-65197 and Japanese Unexamined Patent Publication No. 2001-236497 are not designed to prevent the face of the object from protruding from the frame, so that they cannot be applied to the solution of that problems.

Meanwhile, the technique disclosed in Japanese Patent Publication No. 297793 is aimed at preventing the face (or head) of the object from protruding the frame. However, there is a problem which cannot be solved in the technique disclosed in Japanese Patent Publication No. 297793.

For example, when an image for a plurality of persons is taken as the object, it is difficult to detect the faces or the heads of the object which protrude from the frame based on the distances between the objects and the center and upper parts of the screen. In addition, when the image of the face of one's own is taken by the image-taking device, which is called self-shooting in general, the user does not care in many cases even if the head protrudes because the subject is whether the face is set in the frame or not. In this case, the technique disclosed in Japanese Patent Publication No. 297793 does not meet the request of the user.

### SUMMARY OF THE INVENTION

The present invention was made to solve the above problems and it is an object of the present invention to easily or automatically set a someone's face in a frame.

A flesh color means various kinds of skin colors and it is not limited to specific skin color of a specific kind of people in the following description.

In order to solve the above problems, the present invention comprises the following constitution. A first aspect of the present invention is a frame adjustment device and it comprises characteristic-point detecting portion, determining portion, and frame adjusting portion.

The characteristic-point detecting portion detects a characteristic point from an acquired image. The frame adjustment device is provided inside or outside of a digital camera or a mobile terminal (a mobile phone or PDA (Personal Digital Assistant), for example) and an image is acquired from the frame adjustment device. The characteristic point means a point (a left upper end point or a center point, for example) included in a part (an eye, a nose, a forehead, a mouth, a chin, an eyebrow, a part between eyebrows and a chin, for example).

The determining portion determines whether the face of the object protrudes from the frame which is a region in which the image is acquired based on the characteristic point detected by the characteristic-point detecting portion.

The frame adjusting portion finds frame adjustment data for adjusting the frame based on the determination by the determining portion. The frame adjusting portion finds the fame adjustment data so that the face of the object may be set in the frame. That is, the face of the object is set in the frame of the image to be taken or printed by controlling the frame based on the frame adjustment data by the user, the image-taking device itself or the printing device itself.

According to the first aspect of the present invention, when the face of the object protrudes from the frame in the acquired image, the frame adjustment data is found so that the face of the object may be set in the frame. Therefore, the image in which the face of the object which protruded from the frame can be set in the frame can be easily taken or printed by enlarging the frame in accordance with the frame adjustment data in the image-taking device or the printing device.

Meanwhile, when the face of the object does not protrude from the frame (when the face is small in the frame), an image in which the face is enlarged to such a degree that it does not protrude can be easily taken or printed by shrinking the frame.

The frame adjusting portion according to the first aspect of the present invention may be constituted so as to find the frame adjustment data including a zoom adjustment amount. The first aspect of the present invention as thus constituted is effective when provided in the image-taking device which can adjust the zoom. Thus, the image in which the face of the object is set in the frame can be easily taken by adjusting the zoom of the image-taking device at wide angle, based on the frame adjustment data.

The frame adjusting portion according to the first aspect of the present invention may be constituted so as to find the frame adjustment data including a travel distance of the frame. The first aspect of the present invention as thus constituted is effective even when provided in the image-taking device which cannot adjust the zoom. The image in which the face of the object is set in the frame can be easily taken by moving the frame of the image-taking device based on the frame adjustment data.

The first aspect of the present invention as thus constituted is effective when the face of the object can be set in the frame only by moving the frame without adjusting the zoom. In this case, even if the zoom is not adjusted at wide angle, the image in which the face of the object is set in the frame can be taken in a state the image of the object does not become small.

The frame adjusting portion according to the first aspect of the present invention may be constituted so as to find the frame adjustment data including the adjustment amount of the zoom and the travel distance of the frame. The first aspect of the present invention as thus constituted is effective when the face of the object can be set in the frame only by moving the frame without adjusting the zoom, similar to the above case. Thus, in this case also, even when the zoom is not adjusted at wide angle, the image in which the face of the object is set in the frame can be taken in a state the image of the object does not become small.

The characteristic-point detecting portion according to the first aspect of the present invention may be constituted so as to extract a flesh-colored region from the acquired image. In this case, the determining portion is constituted so as to determine that the face of the object does not protrude from the frame when the flesh-colored region is not detected by the characteristic-point detecting portion. In addition, in this case, when the determining portion determines that the face of the object does not protrudes from the frame, the frame adjusting portion is constituted so as not to find the frame adjustment data.

According to the first aspect of the present invention as thus constituted, it is determined that the face of the object does not protrude from the frame without detecting the characteristic point in some cases. Thus, in this case, the frame adjustment data is not calculated. Therefore, in this case, the process of the first aspect of the present invention is completed at high speed and the image can be taken by the image-taking device at an early stage.

The determining portion according to the first aspect of the present invention may be constituted so as to determine that the face of the object does not protrude from the frame when there is no flesh-colored region positioned at the boundary part of the frame. According to the first aspect of the present invention as thus constituted also, it is determined that the face of the object does not protrude from the frame without detecting the characteristic point in some cases. Thus, in this case, the frame adjustment data is not calculated. Therefore, in this case, the process of the first aspect of the present invention is completed at high speed and the image can be taken by the image-taking device at an early stage.

The characteristic-point detecting portion according to the first aspect of the present invention may be constituted so as to detect a point included in each of eyes and mouth as the characteristic point. In this case, when all of the characteristic points are detected by the characteristic-point detecting portion, the determining portion is constituted so as to determine whether the face of the object protrudes from the frame or not, depending on whether the boundary of the frame exists in the predetermined distance from the reference point found from the characteristic point.

According to the first aspect of the present invention, when the acquired image includes a plurality of faces protruding from the frame, the frame adjusting portion may be constituted to find a plurality of frame adjustment data for setting respective faces protruding from the frame, in the frame and determine frame adjustment data in which all of the protruding faces can be set in the frame, as the final frame adjustment data among the plurality of frame adjustment data.

According to the first aspect of the present invention as thus constituted, the frame adjustment data by which all the faces protruding from the frame can be set in the frame is found. Therefore, the image in which all the faces which protruded from the frame can be set in the frame can be easily taken by controlling the frame of the image-taking device based on the frame adjustment data.

According to the first aspect of the present invention, when the acquired image includes a plurality of faces protruding from the frame, the frame adjusting portion may be constituted so as to find a plurality of frame adjustment data for setting respective faces protruding from the frame in the frame and determine frame adjustment data in which a zoom becomes the widest angle as final frame adjustment data among the plurality of frame adjustment data.

The first aspect of the present invention is effective when it is provided in the image-taking device which can adjust the zoom. Therefore, the image in which all the faces which protruded from the frame can be set in the frame can be easily taken by adjusting the zoom of the image-taking device based on the frame adjustment data in which the zoom becomes the widest angle, among the plurality of frame adjustment data.

A second aspect of the present invention is an image-taking device comprising image-taking portion, characteristic-point detecting portion, determining portion, frame adjusting portion, and frame controlling portion. Here, the image-taking device may be a digital steel camera, or may be a digital video camera.

The image-taking portion acquires the object as image data. The characteristic-point detecting portion detects a characteristic point from the image acquired by the image-taking portion. The determining portion determines whether the face of the object protrudes from the frame of the region in which the image is acquired, based on the characteristic point detected by the characteristic-point detecting portion. The frame adjusting portion finds frame adjustment data for adjusting the frame based on the determination made by the determining portion. The frame controlling portion controls the frame based on the frame adjustment data found by the frame adjusting portion.

According to the second aspect of the present invention, the frame controlling portion automatically controls the frame based on the frame adjustment data found by the frame adjusting portion. Therefore, the image in which the face of the object is set in the frame can be automatically taken without manually operated by the user.

The characteristic-point detecting portion according to the second aspect of the present invention may be constituted so as to detect a characteristic point from the image acquired by the image-taking portion again after the frame is controlled by the frame controlling portion. In this case, the determining portion determines whether the face of the object protrudes from the frame controlled by the frame controlling portion, based on the characteristic point in the image newly acquired. In addition, the frame adjusting portion finds frame adjustment data for adjusting the frame based on the determination made by the determining portion based on the newly acquired image. In addition, in this case, the frame controlling portion controls the frame again based on the frame adjustment data found based on the newly acquired image.

According to the second aspect of the present invention, after the frame is controlled once based on the frame adjustment data, the same process is carried out again on the image newly taken based on the frame. Therefore, when the face protruding from the frame newly appears in the newly taken image, the image in which this face is also set in the frame can be taken.

A third aspect of the present invention is an image-taking device comprising image-taking portion, characteristic-point detecting portion, determining portion, and warning portion.

The image-taking portion acquires an object as image data. The characteristic-point detecting portion detects a characteristic point from the image acquired by the image-taking portion. The determining portion determines whether a face of the object protrudes from a frame of a region in which the image is acquired, based on the characteristic point detected by the characteristic-point detecting portion. The warning portion gives a warning to a user when the determining portion determines that the face of the object protrudes from the frame. The warning portion gives the warning by outputting an image or sound showing the warning or lighting or blinking the lighting device.

According to the third aspect of the present invention, the warning is given to the user when the face of the object protrudes from the frame. Therefore, the user can easily know that the face of the object protrudes from the frame.

For example, when the user takes the face of one's own, the third aspect of the present invention is effective. When the user taken the face of one's own, the user determines whether the face is set in the frame or not by seeing the output such as a display. However, in this case, since the line of sight of the user is oriented not to the lens of the image-taking device but to the display, an unnatural image is taken. However, according to the third aspect of the present invention, it is not necessary to adjust the position of the camera (the position of the frame) while seeing the display, and the user may take the image at the position of the frame in a state the warning is not generated.

A fourth aspect of the present invention is a printing device comprising image-inputting portion, characteristic-point detecting portion, determining portion, frame adjusting portion and printing portion. The printing device may be a printer which prints out a digital image or may be a device such as a minilab machine which prints an image on an printing paper from a film.

The image-inputting portion acquires an image data from a recording medium. The characteristic-point detecting portion detects a characteristic point from the image acquired by the image-inputting portion. The determining portion determines whether a face of the object protrudes from a frame which becomes the printing region, based on the characteristic point detected by the characteristic point detecting portion. The frame adjusting portion finds frame adjustment data for adjusting the frame based on the determination by the determining portion. The printing portion prints the frame based on the frame adjustment data found by the frame adjusting portion.

According to the fourth embodiment of the present invention, the frame controlling portion automatically controls the frame based on the frame adjustment data found by the frame adjusting portion. Therefore, the image in which the face of the object is set in the frame can be automatically printed out without a manual operation by the user.

A fifth aspect of the present invention is a frame adjusting method comprising a step of detecting a characteristic point from an acquired image, a step of determining whether a face of an object protrudes from a frame which becomes a region in which the image is acquired, based on the detected characteristic point, and a step of finding frame adjustment data for adjusting the frame, based on the result made at the determining step.

A sixth aspect of the present invention is a frame adjusting method comprising a step of detecting a characteristic point from an acquired image, a step of determining whether a face of an object protrudes from a frame which becomes a region in which the image is acquired, based on the detected characteristic point, a step of finding frame adjustment data for adjusting the frame, based on the result made at the determining step, and a step of controlling the frame based on the frame adjustment data.

A seventh aspect of the present invention is a method of detecting protrusion of an object comprising a step of detecting a characteristic point from an acquired image and a step of determining whether a face of an object protrudes from a frame depending on whether a boundary of a frame of a region in which the image is acquired exists in a predetermined distance from a reference point found from the characteristic point.

An eighth aspect of the present invention is a program for making a processing unit carry out a step of detecting a characteristic point from an acquired image, a step of determining whether a face of an object protrudes from a frame which becomes a region in which the image is acquired, based on the detected characteristic point, and a step of finding frame adjustment data for adjusting the frame, based on the result made at the determining step

A ninth aspect of the present invention is a program for making a processing unit carry out a step of detecting a characteristic point from an acquired image, a step of determining whether a face of an object protrudes from a frame which becomes a region in which the image is acquired, based on the detected characteristic point, a step of finding frame adjustment data for adjusting the frame, based on the result made at the determining step, and a step of controlling the frame based on the frame adjustment data.

A tenth aspect of the present invention is a program for making a processing unit carry out a step of detecting a characteristic point from an acquired image and a step of determining whether a face of an object protrudes from a frame depending on whether a boundary of a frame of a region in which the image is acquired exists in a predetermined distance from a reference point found from the characteristic point.

### BRIEF DESCRIPTION OF THE DRAWINGS

FIG. 1 shows an example of a functional block diagram of image-taking devices 5a and 5b.

FIG. 2 shows a view of an example of an image in which two characteristic points are detected.

FIG. 3 shows a view of criteria when it is determined whether a face protrudes from a frame or not in a case three characteristic points are detected.

FIG. 4 shows a view of a zoom adjustment amount when two characteristic points are detected.

FIG. 5 shows a flowchart of an example of processes of the image-taking device 5a.

FIG. 6 shows a flowchart of an example of processes of a frame adjustment device 1a.

FIG. 7 shows a flowchart of an example of processes of the frame adjustment device 1a.

FIG. 8 shows a flowchart of an example of processes of the frame adjustment device 1a.

FIG. 9 shows an image example in which there is a plurality of flesh-colored regions positioned at a boundary part of a frame.

FIG. 10 shows a flowchart of an example of processes of the image-taking device 5b.

FIG. 11 shows an example of a functional block diagram of an image-taking device 5c.

FIG. 12 shows a flowchart of an example of processes of the image-taking device 5c.

FIG. 13 shows an example of a functional block diagram of an image-taking device 5d.

FIG. 14 shows a flowchart of an example of processes of the image-taking device 5d.

FIG. 15 shows a flowchart of an example of processes when an image-taking device 5 takes a moving image.

### DESCRIPTION OF THE PREFERRED EMBODIMENTS

Next, a description is made of an image-taking device comprising a frame adjustment device according to the present invention with reference to the drawings. In addition, the following description for the image-taking device and the frame adjustment device is illustrative and their constitutions are not limited to the following description.

(First Embodiment)

((System Constitution))

First, a description is made of an image-taking device 5a according to a first embodiment of the image-taking device. The image-taking device 5a comprises a frame adjustment device 1a which is an embodiment of the frame adjustment device according to the present invention.

The frame adjustment device 1a and the image-taking device 5a comprise a CPU (Central processing unit)., a main memory unit (RAM), and an auxiliary memory unit which are connected through buses, as hardware. The auxiliary memory unit is constituted by a nonvolatile memory unit. Here, the nonvolatile memory unit means a ROM (Read-Only Memory) including an EPROM (Erasable Programmable Read-Only Memory), an EEPROM (Electrically Erasable Programmable Read-only Memory), a mask ROM and the like, a FRAM (Ferroelectric RAM), a hard disk and the like. Each unit may be provided in each of the frame adjustment device 1a and image-taking device 5a or may be provided as a common unit to both. When it is used in common by both, the frame adjustment device 1a may be provided in the image-taking device 5a as an adjustment unit serving as one functioning unit of the image-taking device 5a. In addition, the frame adjustment device 1a may be constituted as an exclusive chip constituted as a hardware.

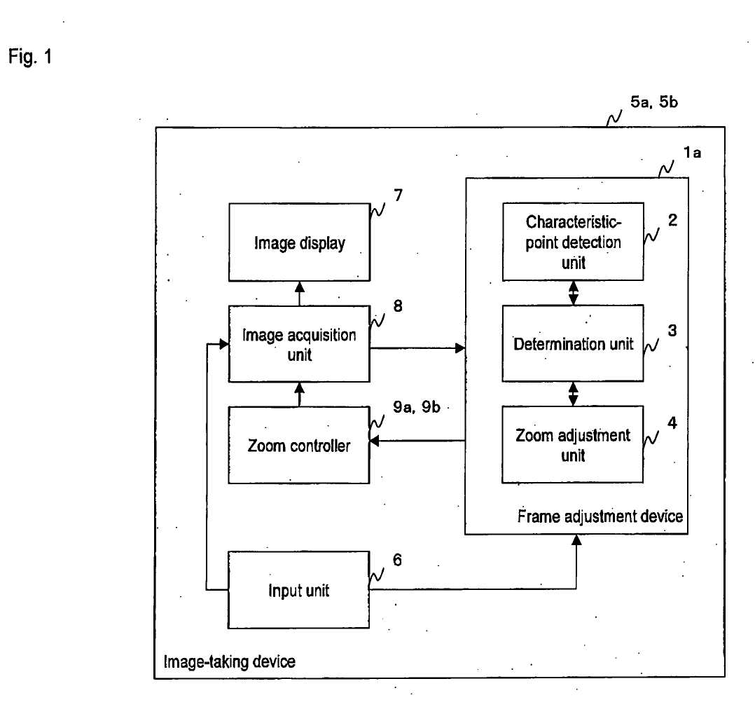

FIG. 1 show a functional block diagram of the frame adjustment device 1a and the image-taking device 5a. The frame adjustment device 1a functions as a device comprising a characteristic-point detection unit 2, a determination unit 3, a zoom adjustment unit 4 and the like when various kinds of programs (OS, application and the like) stored in the auxiliary memory unit are loaded to the main memory unit and carried out by the CPU. The characteristic-point detection unit 2, and the determination unit 3 and the zoom adjustment unit 4 are implemented when a frame adjustment program is carried out by the CPU. In addition, characteristic-point detection unit 2, and the determination unit 3 and the zoom adjustment unit 4 may be constituted as exclusive chips, respectively.

The image-taking device 5a functions as a device comprising the frame adjustment device 1a, an input unit 6, an image display 7, an image acquisition unit 8, a zoom controller 9a and the like when various kinds of programs (OS, application and the like) stored in the auxiliary memory unit are loaded to the main memory unit and carried out by the CPU.

A description is made of each functioning unit provided in the frame adjustment device 1a with reference to FIG. 1.

(Characteristic-Point Detection Unit)

The characteristic-point detection unit 2 detects a characteristic point in an input image. First, the characteristic-point detection unit 2 extracts a flesh-colored region from the input image. At this time, the characteristic-point detection unit 2 extracts the flesh-colored region by masking a region other then the flesh-colored region using a Lab space method, for example.

Then, the characteristic-point detection unit 2 deepens or lightens the color of the extracted flesh-colored region. For example, the characteristic-point detection unit 2 converts the input image to a gray-scale image of 256 gradations. A formula 1 is used in such image conversion in general.

[Formula 1]

(Image of Formula 1)

According to the formula 1, reference characters R, G and B designate 256 graduation PGB components of each pixel of the input image. In addition, in the formula 1, reference character Y designates a pixel value in the gray-scale image after conversion, that is, a gradation value.

Then, the characteristic-point detection unit 2 detects a plurality of parts of a face by performing template matching to the gray-scale image using a previously set template. The characteristic-point detection unit 2 detects a right eye, a left eye and a mouth as parts of the face. The characteristic-point detection unit 2 detects a center point of each part as a characteristic point. The template used in the template matching is previously formed by an average image of the eye or an average image of the mouth.

(Determination Unit)

The determination unit 3 makes some determinations necessary for the processing of the frame adjustment device 1a.

The determination unit 3 counts the number of flesh-colored regions extracted by the characteristic-point detection unit 2. The determination unit 3 finds the flesh-colored region in the image as a region which can be a face. The determination unit 3 selects the subsequent process depending on the number of such flesh-colored regions.

In addition, the determination unit 3 determines whether there is a face protruding from a frame, using the characteristic point detected by the characteristic-point detection unit 2. The frame shows a region in which the image is acquired. The determination unit 3 determines the existence of the face protruding from the frame by the number of detected characteristic points or their positional relation, for example.

The determination unit 3 determines that the flesh-colored region is not the face when the number of characteristic points detected from the flesh-colored region is less than two. In addition, the determination unit 3 determines that the flesh-colored region is the face when the number of the detected characteristic points is two.

In addition, when the number of the detected characteristic points is three, the determination unit 3 determines that the flesh-colored region is the face. It is determined whether the face protrudes from the frame using criteria peculiar to the case the number of the characteristic points is two and the case the number of the characteristic points is three. Hereinafter, respective criteria are described.

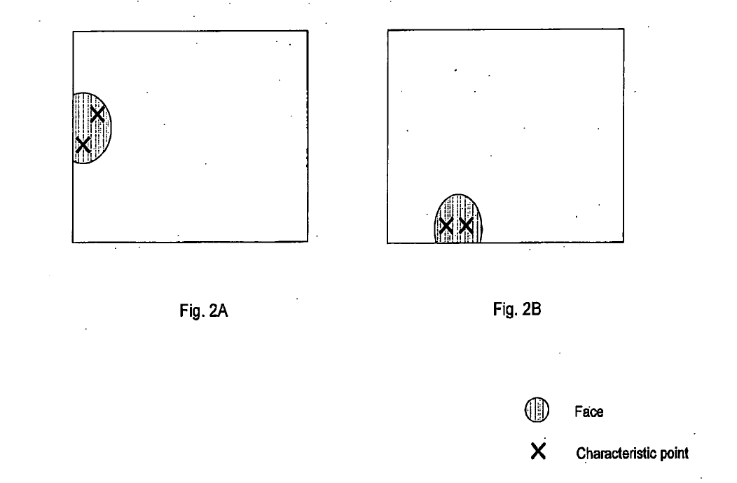

FIG. 2 shows an example of an image when two characteristic points are detected in the flesh-colored region. FIG. 2A shows an example when the face protrudes in the lateral direction of the frame. FIG. 2B shows an example when the face protrudes in the vertical direction of the frame. In either case, since the third characteristic point is not detected, it is clear that the face protrudes. Therefore, the determination unit 3 determines that the flesh-colored region in which only two characteristic points are detected is the face protruding from the frame.

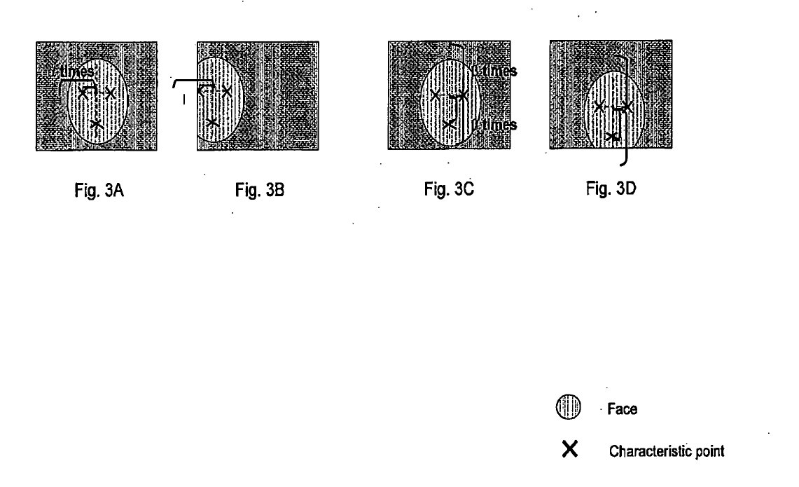

FIG. 3 shows an example of an image when three characteristic points are detected in the flesh-colored region. FIG. 3A and FIG. 3B show criteria when it is determined whether there is a boundary of the frame in a specific distance from a reference point in the lateral direction (lateral specific distance). When the boundary of the frame exists within the specific distance from the reference point in the lateral direction, the determination unit 3 determines that the face protrudes in the lateral direction.

First, the determination unit 3 finds a straight line passing the characteristic point showing the right eye and the characteristic point showing the left eye as a lateral reference axis. In addition, the determination unit 3 finds a center point between the characteristic point showing the right eye and the characteristic point showing the left eye as a reference point. Furthermore, the determination unit 3 finds a distance between the reference point and the characteristic point showing the right eye or the characteristic point showing the left eye as a lateral reference distance. Then, the determination unit 3 determines whether the boundary of the frame exists in a distance which is α times as long as the lateral reference distance (lateral specific distance) in both directions to the right eye and the left eye from the reference point along the lateral reference axis.

FIG. 3C and FIG. 3D show criteria when it is determined whether there is a boundary of the frame in a specific distance from a reference point in the vertical direction (vertical specific distance). When the boundary of the frame exists within the specific distance from the reference point in the vertical direction, the determination unit 3 determines that the face protrudes in the vertical, direction.

First, the determination unit 3 finds a straight line passing the reference point and the characteristic point showing the mouth as a vertical reference axis. In addition, the determination unit 3 finds a distance between the reference point and the characteristic point showing the mouth as a vertical reference distance. Then, the determination unit 3 determines whether the boundary of the frame exists in a distance (vertical specific distance) which is β times as long as the vertical reference distance in both directions to the mouth and the opposite direction along the vertical reference axis.

The values of α and β may be set arbitrarily by a designer or a user and 2.5 and 2.0 are set, for example. The value of α does not necessarily coincide with the value of β. In addition, when the values of α and β are set at small values, the criterion of the face protrusion is moderated while when they are set at large values, the criterion of the face protrusion becomes strict. The values of α and β are preferably set by a designer or a user in this respect. For example, when the user thinks that it is not necessary to include a head part nor a chin part in the frame, a required image can be acquired by setting the value β at a small value.

(Zoom Adjustment Unit)

When it is determined that the face protruding the frame exists by the determination unit 3, the zoom adjustment unit 4 finds an adjustment amount of a zoom. The zoom adjustment unit 4 finds the adjustment amount of the zoom so that the face protruding from the frame may be set in the frame, depending on a distance between the characteristic points in the flesh-colored region which is determined to be the protruded face.

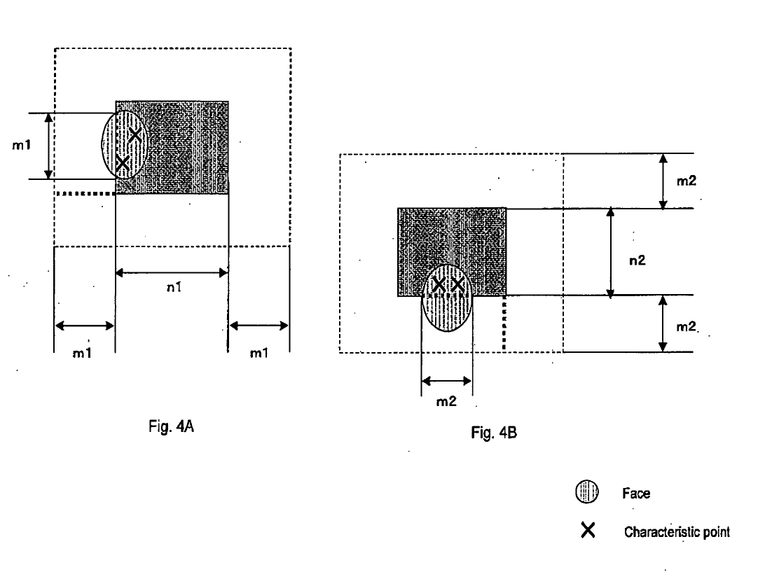

FIG. 4 shows an example of a zoom adjustment amount when two characteristic points are detected. FIG. 4A shows an example when one eye and the mouth are detected as characteristic points. In this case, the zoom adjustment unit 4 finds the zoom adjustment amount such that a field angle is increased according to the number of pixels of the flesh-colored region on the frame boundary in the vertical direction, for example. More specifically, when it is assumed that the above number of pixels is m1 and the original number of pixels of the frame in the lateral direction is n1, the zoom adjustment unit 4 finds the zoom adjustment amount so that the image included in a range of n1+(2×m1) (a range shown by a doted line in FIG. 4A) may be set in the frame.

FIG. 4B shows an example when both eyes are detected as characteristic points. In this case, the zoom adjustment unit 4 finds the zoom adjustment amount such that the field angle is increased according to the number of pixels of the flesh-colored region in the lateral direction on the frame boundary, for example. More specifically, when it is assumed that the above number of pixels is m2 and the original number of pixels of the frame in the vertical direction is n2, the zoom adjustment unit 4 finds the zoom adjustment amount so that the image included in a range of n2+(2×m2) (a range shown by a doted line in FIG. 4B) may be set in the frame. This zoom may be an optical zoom or a digital zoom.

When three characteristic points are detected, the zoom adjustment unit 4 finds the zoom adjustment amount so that the boundary of the frame may not exist in the lateral and vertical specific distances from the reference point along the lateral and vertical reference axes.

Next, a description is made of each of the functioning part other than the frame adjustment device 1a among the functioning parts provided in the image-taking device 5a, with reference to FIG. 1.

(Input Unit)

The input unit 6 comprises a button, a unit which can be pushed (dial or the like), a remote controller and the like. The input unit 6 functions as a user interface, so that various kinds of orders from the user are input to the image-taking device 5a. For example, the input unit 6 is a button for inputting a fact that the user clicks a shutter and when the button is pressed by half, the frame adjustment device 1a starts the operation.

(Image Display)

The image display 7 comprises a finder, liquid crystal display and the like. The image display 7 provides an image which is almost the same as an image to be taken, to the user. The image displayed in the image display 7 needs not be exactly the same as the image taken actually and it may be variously designed by the user of the image-taking device 5a. The user can carry out framing (setting a range to be taken) based on the image provided by the image display 7.

(Image Acquisition Unit)

The image acquisition unit 8 comprises an optical sensor such as a CCD (Charge-Coupled Devices), CMOS (Complementary Metal-Oxide Semiconductor) and the like. In addition, the image acquisition unit 8 is constituted so as to be provided with the nonvolatile memory unit and record image information acquired by the optical sensor in the nonvolatile memory unit.

(Zoom Controller)

The zoom controller 9a carries out zoom adjustment based on an output from the zoom adjustment unit 4, that is, the zoom adjustment amount found by the zoom adjustment unit 4. The zoom may be an optical zoom or may be a digital zoom.

((Operation Example))

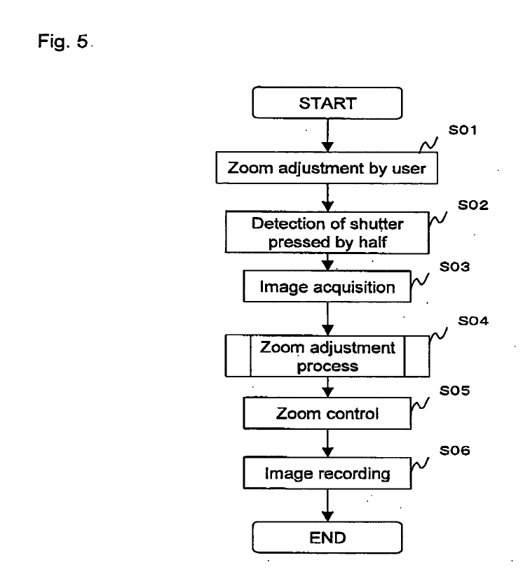

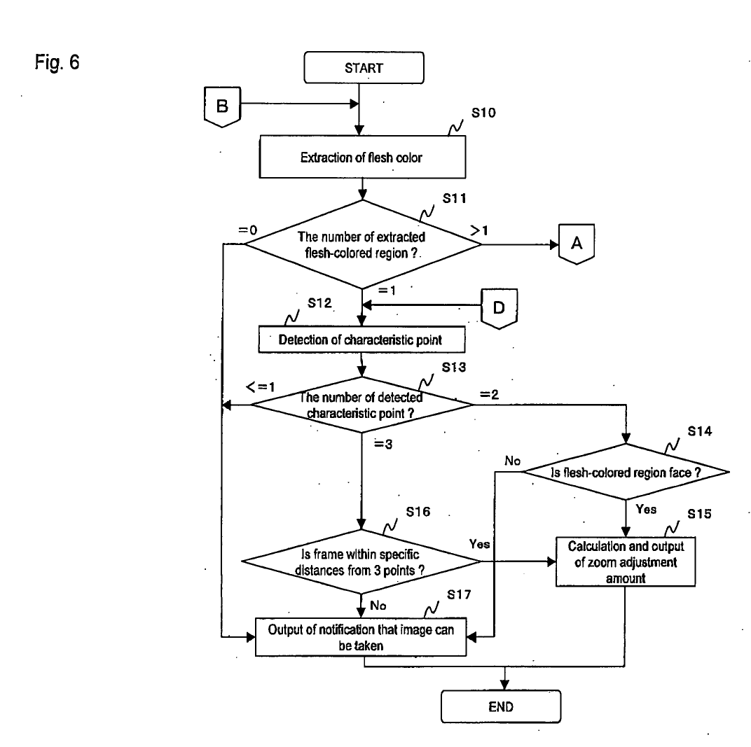

FIG. 5 shows a flowchart of an operation example of the image-taking device 5a. FIGS. 6 to 8 show flowcharts of operation examples of the frame adjustment device 1a. The operation examples of the image-taking device 5a and the frame adjustment device 1a are described with reference to FIGS. 5 to 8.

First, a zoom adjustment is made by the user at step S01. (FIG. 5). Then, the user presses the shutter button by half when completes the framing. At this time, the input unit 6 detects that the shutter button is pressed by half by the user at step S02. When the input unit 6 detects that the shutter button is pressed by half, the image acquisition unit 8 acquires the image framed by the user, that is, the image to be taken at this point and input the data of the image to the frame adjustment device 1a at step S03.

When the image is input, the frame adjustment device 1a carries out a zoom adjustment process at step S04. The zoom adjustment process will be described below. The frame adjustment device 1a outputs the zoom adjustment amount or a notification that the image can be taken after the zoom adjustment process. When the zoom adjustment amount is output, the zoom controller 9a controls the zoom according to the zoom adjustment amount at step S05. After the zoom control or when the notification that the image can be taken is output from the frame adjustment device 1a, the zoom controller 9a gives (output) the notification that the image can be taken to the image acquisition unit 8.

When the image acquisition unit 8 receives the notification that the image can be taken, records the image acquired through a lens in a recording medium at step S06.

(Zoom Adjustment Process)

A description is made of the zoom adjustment process performed by the frame adjustment device 1a with reference to FIGS. 6 to 8.

First, the characteristic-point detection unit 2 masks a region other than the flesh-colored region in the input image and extracts the flesh-colored region at step S10. This process is carried out using the Lab space method, for example. Then, the determination unit 3 counts the number of the extracted flesh-colored regions. When the number of the flesh-colored regions is 0 at step S11, the determination unit 3 outputs the notification that the image can be taken at step S17 and the zoom adjustment process is completed.

When the number of the flesh-colored regions is 1 at step S1, the characteristic-point detection unit 2 detects the characteristic point from the flesh-colored region at step S12. Then, the determination unit 3 counts the number of the detected characteristic points. When the number of the detected characteristic points is not more than 1 at step S13, the determination unit 3 outputs the notification that the image can be taken at step S17 and then the zoom adjustment process is completed.

When the number of the detected characteristic points is 2 at step S13, the determination unit 3 acquires positional information of the two characteristic points. Then, the determination unit 3 determines whether the extracted flesh-colored region is a someone's face based on the positional information of the two characteristic points. When the determination unit 3 determines that the flesh-colored region is the face at step S14 (YES), the zoom adjustment unit 4 calculates and outputs the zoom adjustment amount at step S15 and then the zoom adjustment process is completed. Meanwhile, when the determination unit 3 determines that the flesh-colored region is not the face at step S14 (NO), the determination unit 3 outputs the notification that the image can be taken at step S17 and then the zoom adjustment process is completed.

When the number of the detected characteristic points is three at step S13, the determination unit 3 determines whether the face protrudes from the frame or not, based on the positional information of the three characteristic points at step S16. At this time, the determination unit 3 determines whether there is a boundary of the frame in lateral and vertical specific distances from the reference point.

When there is no boundary of the frame in the lateral and vertical distances from the reference point at step S16 (NO) as shown in FIGS. 3A and 3C, the determination unit 3 outputs the notification that the image can be taken at step S17. Meanwhile, when the boundary of the frame exists in the lateral or vertical distance at step S16 (YES) as shown in FIGS. 3B and 3D, the zoom adjustment unit 4 calculates and output the zoom adjustment amount at step S15. Then, in either case, the zoom adjustment process is completed.

The description is returned to a branching process at step S11. When the number of the extracted flesh-colored region is more than 1, the processes after step S20 are carried out.

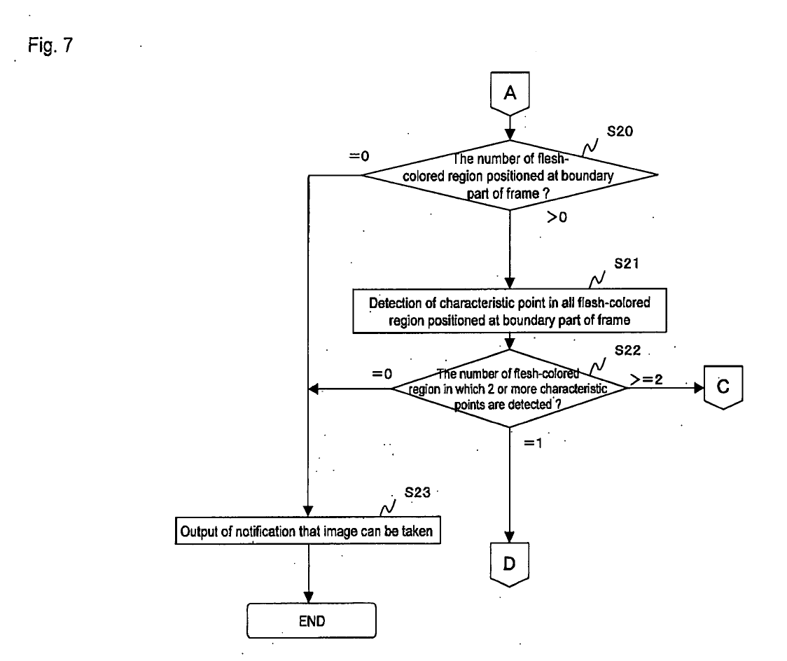

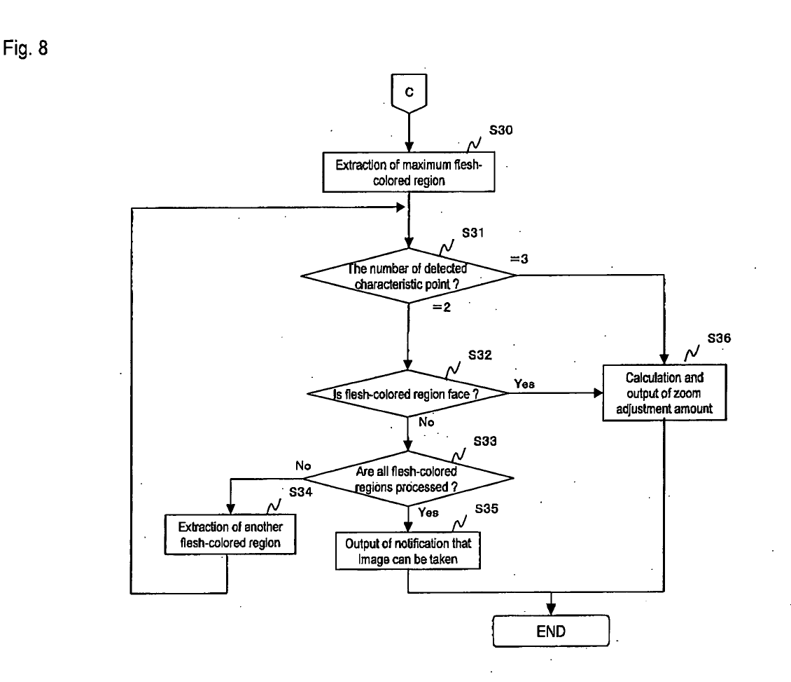

Next, the operations after step S20 are described with reference to FIGS. 7 and 8. The determination unit 3 counts the number of flesh-colored regions positioned at the boundary part of the frame. The flesh-colored region positioned at the boundary part of the frame means the flesh-colored region in which one part or an entire part thereof is contained in a region between the boundary of the frame and the inner part from the boundary by a distance corresponding to the predetermined number of pixels. The predetermined number of pixels may be 1 or more and it may be freely set by the designer.

When the number of flesh-colored regions positioned at the boundary part of the frame is 0 at step S20, the determination unit 3 outputs the notification that the image can be taken at step S23 and then the zoom adjustment process is completed.

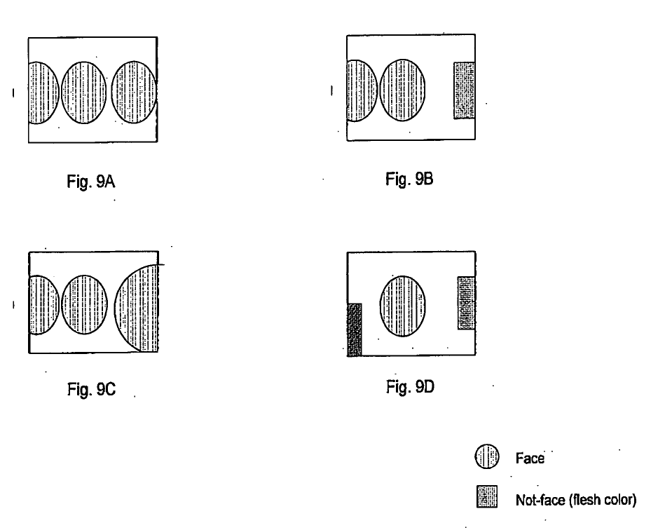

Meanwhile, when the number of the flesh-colored regions positioned at the boundary part of the frame is more than 0 at step S20, the characteristic-point detection unit 2 carries out detection of the characteristic point in all of the flesh-colored regions positioned at the boundary part of the frame at step S21. Then, the determination unit 3 counts the number of flesh-colored regions in which two or more characteristic points are detected among the flesh-colored regions positioned at the boundary part of the frame at step S22. FIG. 9 shows a pattern of an input image when the number of flesh-colored regions positioned at the boundary part of the frame is not less than 1. The contents of the process at step S22 are described with reference to FIG. 9.

In the images to be processed at step S22, there are four patterns such as an image in which only the flesh-colored region of one face protrudes (FIG. 9A), an image in which the flesh-colored region of one face and the flesh-colored region other than the face (not-face part) protrude (FIG. 9B), an image in which flesh-colored regions of the plural faces protrude (FIG. 9C) and an image in which only the flesh-colored regions of the not-face parts protrudes (FIG. 9D). According to the processes after step S22, the processes are performed so as to be classified in three cases such as the case of A, the case of B or C and the case of D. These classification is carried out depending on the number of flesh-colored regions positioned at the boundary part of the frame and having two characteristic points detected.

When the number of the flesh-colored regions in which two or more characteristic points are detected is 0 at step S22 (corresponding to FIG. 9D), the determination unit 3 outputs the notification that the image can be taken at step S23 and then the zoom adjustment process is completed.

When the number of the flesh-colored regions in which two or more characteristic points are detected is 1 at step S22 (corresponding to FIG. 9A or 9B), the frame adjustment device 1a performs the processes after step S12 (refer to FIG. 4).

When the number of the flesh-colored regions in which two or more characteristic points are detected is the plural number at step S22 (corresponding to FIG. 9C), the frame adjustment device 1a performs the processes after step S30 (refer to FIG. 8)

Then, the processes after step S30 are described with reference to FIG. 8. The determination unit 3 extracts a maximum flesh-colored region among the flesh-colored regions positioned at the boundary part of the frame and having two or more characteristic points at step S30.

Then, the determination unit 3 counts the number of characteristic points detected in the extracted flesh-colored region. When the number of the detected characteristic points is 2 at step S31, the determination unit 3 acquires the positional information of the two points and determines whether the flesh-colored region is the face or not based on this positional information. When the flesh-colored region is the face at step S32 (YES), the zoom adjustment unit 4 calculates and outputs the zoom adjustment amount based on the position of the characteristic points in the flesh-colored region at step S36 and then the zoom adjustment process is completed.

Meanwhile, when the flesh-colored region is not the face at S32 (NO), the determination unit 3 determines whether the processes after step S31 are completed for all of the flesh-colored regions positioned at the boundary part of the frame and having two characteristic points. When the processes are not completed at step S33 (NO), the determination unit 3 extracts another flesh-colored region on which the processes are not performed at step S34 and the processes after step S31 are performed for the extracted flesh-colored region. At this time, the determination unit 3 may be constituted so as to extract the flesh-colored region which is the largest next after the flesh-colored region processed at the last time.

Meanwhile, when the processes for all of the flesh-colored regions are completed at step S33 (YES), the determination unit 3 outputs the notification that the image can be taken at step S35 and then the zoom adjustment process is completed.

The description is returned to the branching operation at step S31. When the number of the detected characteristic points is 3 at step S31, the zoom adjustment unit 4 calculates and outputs a zoom adjustment amount based on the positions of the characteristic points in the flesh-colored region at step S36 and then the zoom adjustment process is completed.

((Operation/Effect))

According to the image-taking device 5a comprising the frame adjustment device 1a, when a frame in which an image is taken is finally decided, it is determined whether zoom adjustment by the frame adjustment device 1a is necessary or not. At this time, when there is a face which protrudes from the frame, the frame adjustment device 1a determines that the zoom adjustment is necessary, and when there is no such face, it determines that the zoom adjustment is not necessary. When the zoom adjustment is necessary, the zoom adjustment unit 1a finds an appropriate zoom adjustment amount. At this time, the frame adjustment device 1a finds the zoom adjustment amount such that the face protruding from the frame may be set in the frame. Then, the zoom controller 9a controls the zoom based on the zoom adjustment amount found by the frame adjustment device 1a.

Therefore, according to the image-taking device 5a, even if a face of an object protrudes from the frame at a position decided by the user, the zoom is automatically controlled so that the protruding face may be set in the frame. Therefore, the face of the object is prevented from shot in a state it protrudes from the frame.

In addition, the frame adjustment device 1a performs first the extracting process of the flesh-colored region which needs a small amount of calculation as compared with the pattern matching at parts of the face and when the number of the flesh-colored region is 0, the notification that the image can be taken is output. Therefore, when there is no person as an object at all, that is, when the number of the flesh-colored region is 0, the notification that the image can be taken is immediately output, so that the image can be taken immediately without wasting any process.

In addition, according to the frame adjustment device 1a, since the object to be set in the frame is automatically determined based on the criteria, depending on the number or the position of the characteristic points, it is not necessary for the user to manually designate the object to be set in the frame.

Still further, according to the frame adjustment device 1a, when it is determined where the face of the object exists or not, the face itself is not detected but a part of the face (a mouth or both eyes, for example) is detected. Therefore, even when a face protrudes too much from the frame so that it cannot detected by general recognition of the face (only a part is included in an input image), it can be detected.

In addition, according to the frame adjustment device 1a, the zoom adjustment amount is automatically calculated so that the protruding face can be set in the frame, depending on the position of the detected characteristic point. Therefore, the protruding face can be set in the frame by one zoom adjustment basically. Thus, it is not necessary to repeat the zoom adjustment and determination made whether the face is set in the frame or not for any face protruding from the frame. As a result, the process before the image is taken can be performed at high speed.

In addition, according to the frame adjustment device 1a, even when a head part or an ear part protrudes from the frame, by setting the values of α and β appropriately, the image can be taken as it is based on determination such that the face itself does not protrude. Therefore, the criteria whether the face is included in the frame can be varied based on the will of a person (a user or a designer of the image-taking device 5a, for example) who sets the values of α and β. For example, according to a mobile phone with built-in camera having small number of pixels, when the entire head part is included in the frame, the part of the face becomes small. Therefore, in this case, the α and β are set at small values so that even when the head part protrudes the frame, the determination is made such that the face does not protrude, and the face can be mainly shot. Alternatively, when it is necessary to take some space between the top of the head and the boundary of the frame, for example in a case of a certificate photograph, the values of α and β may be largely set.

However, it is needless to say that the values of α and β can be set so that when the head part or the ear part protrudes from the frame, the zoom adjustment is performed based on the determination that the face protrudes from the frame.

((Variation))

The frame adjustment device 1a may be constituted such that when there is a plurality of faces protruding from the frame, a zoom adjustment amount for each of the faces is found and the most largest amount is output. Thus, the zoom can be controlled so that the protruding all of the faces can be set in the frame without prioritizing the size of the protruding face.

In addition, the zoom adjustment unit 4 may find the zoom adjustment amount such that a field angle is increased in accordance with a maximum value among the number of pixels of the flesh-colored region in the vertical direction, for example. In this case, the process is carried out, assuming that the maximum number is m1. Similarly, the zoom adjustment unit 4 may find the zoom adjustment amount such that a field angle may be increased in accordance with a maximum value among the number of pixels of the flesh-colored region in the lateral direction, for example. In this case, the process is carried out, assuming that the maximum number is m2.

In addition, when there is a plurality faces which protrude the frame, the frame adjustment device 1a may be constituted so as to find zoom adjustment amounts for all of the faces having flesh-colored region of a predetermined size or more, and output the most largest amount of the zoom adjustment. In this constitution, the zoom can be controlled so that all of the faces having the flesh-colored region of the predetermine size or more can be set in the frame.

In addition, the determination unit 3 may be constituted such that a flesh-colored region having a size smaller than the predetermine size may not be processed regardless of the number of the characteristic points. In this constitution, when a small face which is not intended to be an object is taken by chance, the process for including that small face in the frame can be prevented.

In addition, the frame adjustment device 1a may be constituted to generate a warning to the user through the image-taking device 5a when the number of the detected characteristic point is 1 or less in the process at step S13. In this case, the image-taking device 5a needs to comprise a warning unit for generating the warning to the user. The constitution of the warning unit is described in a section of a fourth embodiment. In addition, in this case, after the warning is generated, the operation may be returned to the step S03 or may be returned to the step S01.

In addition, the frame adjustment device 1a and the image-taking device 5a may be constituted such that the warning is continued to be generated until two or more characteristic points are detected. In this constitution, even when the face of the object largely protrudes from the frame, the user who received the warning manipulates the image-taking device 5a to detect two or more characteristic points in the frame so that the image is taken surely with the face set in the frame. Such constitution is effectively applied to a case the face is surely contained in the object as a “self-shooting mode”, for example.

In addition, the determination unit 3 may be constituted so as not to determine whether the flesh-colored region in which two characteristic points are detected is the face or not, but determine that the region is the face unconditionally.

In addition, the determination unit 3 may be constituted so as not to determine the flesh-colored region in which three characteristic points is the face unconditionally, but to determine whether the region is face or not from properties and positional relation of the detected three points. For example, it may be constituted so as to determine that the region is not the face when all three characteristic points show the same part, for example. In addition, it may be constituted so as to determine it is not the face when three characteristic points are arranged on almost a straight line. In this constitution, after it is determined that there are three characteristic points in the process at step S13 (refer to FIG. 6), it is determined whether flesh-colored region is the face or not before the process at step S16. When the flesh-colored region is the face, the process at step S16 is performed but when the flesh-colored region is not the face, the process at step S17 is performed. In addition, in this constitution, after it is determined that there are three characteristic points in the process at step S31 (refer to FIG. 8), it is determined whether the flesh-colored region is the face or not before the process at step S36. When the flesh-colored region is the face, the process at step S36 is performed and when the flesh-colored region is not the face, the process at step S33 is performed.

In addition, the determination unit 3 may be constituted so as to make determination at the branch based on the number of the flesh-colored regions positioned at the boundary part of the frame among the extracted flesh-colored regions in the process at step S11 (refer to FIG. 6). In this constitution, when there are plural number of flesh-colored regions at step S11, the process at step S20 (refer to FIG. 7) is omitted and the processes after S21 are carried out. In this constitution, even if there is one or more flesh-colored region in the image, when there is no face protruding from the frame, the determination unit 3 outputs the notification that the image can be taken without performing the process such as a pattern matching of the part of the face (that is, detection of the characteristic point) and the like. Therefore, the image can be taken at high speed without performing unnecessary process.

(Second Embodiment)

((System Constitution))

A description is made of an image-taking device 5b of a second embodiment about a point different from the image-taking device 5a. The image-taking device 5b is different from the image-taking device 5a in that a zoom controller 9b is provided instead of the zoom controller 9a. In addition, although the main function of the zoom controller 9b is not different from the zoom controller 9a, its processing flow is different.

((Operation Example))

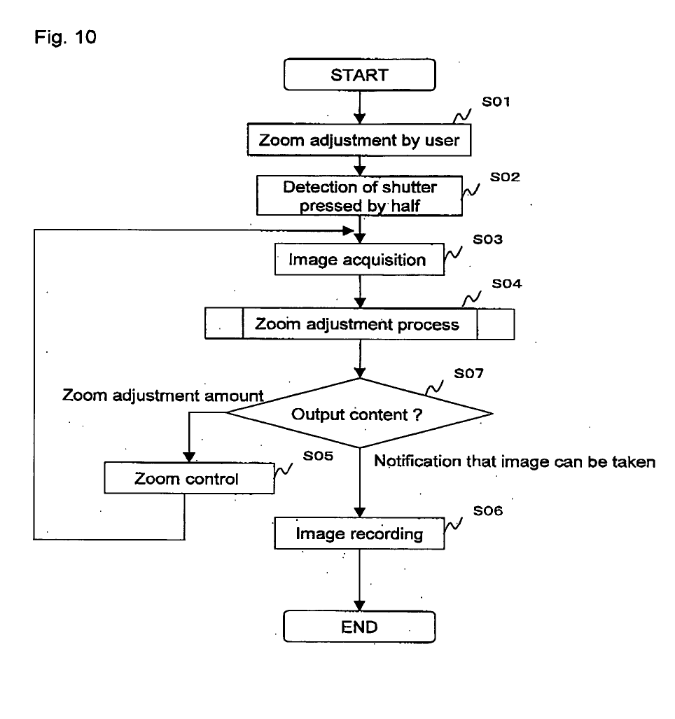

FIG. 10 shows a flowchart of processes of the image-taking device 5b. Hereinafter, the processes of the image-taking device 5b which is different from those of the image-taking device 5a are described.

When a frame adjustment device 1a completes the zoom adjustment process at step S04, the zoom controller 9b determines whether the output content from the frame adjustment device 1a is the zoom adjustment amount or the notification that the image can be taken. When it is the zoom adjustment amount at step S07, the zoom controller 9b controls the zoom in accordance with the zoom adjustment amount at step S05. Then, the image-taking device 5b performs the processes after step S03 again.

Meanwhile, the output content from the frame adjustment device 1a is the notification that the image can be taken at step S07, the zoom controller 9b gives the notification that the image can be taken to the image acquisition unit 8. When the image acquisition unit 8 receives the notification, it records the image acquired through a lens on a recording medium at step S06.

((Operation/Effect))

According to the image-taking device 5b, when the zoom is controlled in accordance with the zoom adjustment amount output from the frame adjustment device 1a, the zoom adjustment process is performed on the image again after the zoom is controlled. Therefore, when the protruding face is newly detected in the image after the zoom controlling, the zoom is controlled again so as to set this face in the frame also. Therefore, the face which is not contained in the frame at all at the zoom adjustment by the user at step S01 can be also set in the frame by the zoom adjustment process and zoom controlling.

(Third Embodiment)

((System Constitution))

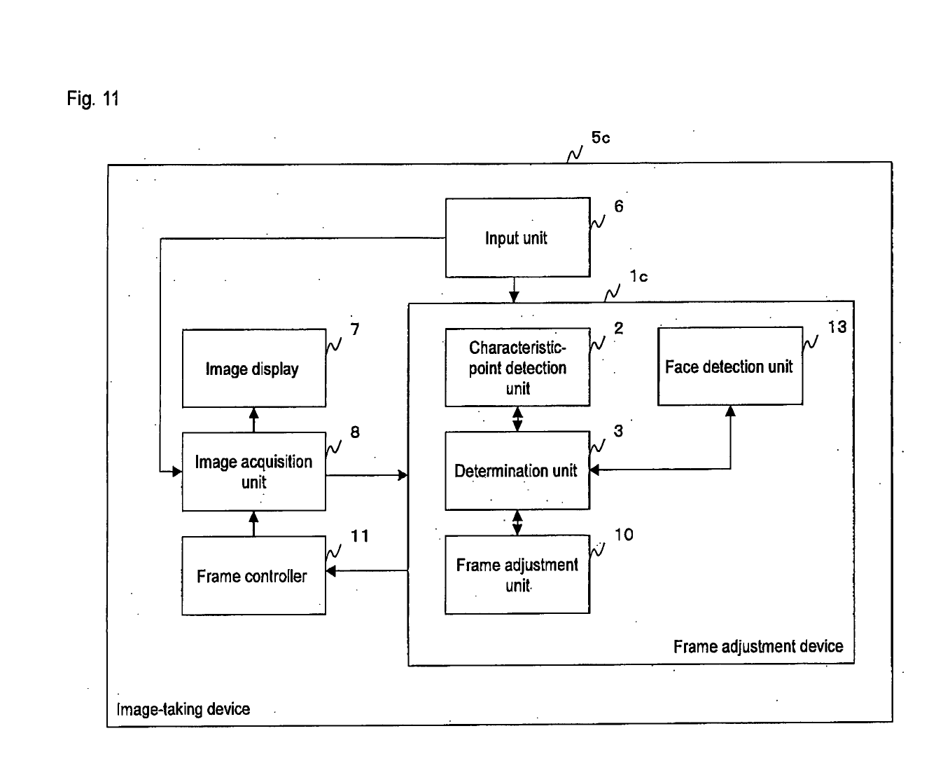

A description is made of an image-taking device 5c of a third embodiment about a point different from the image-taking device 5a. FIG. 11 shows a functional block diagram of the image-taking device 5c. The image-taking device 5c is different from the image-taking device 5a in that a frame adjustment device 1c and a frame controller 11 are provided instead of the frame adjustment device 1a and the zoom controller 9a.

The frame adjustment device 1c is different from the frame adjustment device 1a in that a frame adjustment unit 10 is provided instead of the zoom adjustment unit 4. In addition, the frame adjustment device 1c is different from the frame adjustment device 1a in that a face detection unit 13 is provided.

According to a general digital image-taking device, an image actually acquired by an image acquisition unit (an image constituted by effective pixels) comprises an image having a range wider than that of the image in the frame (an image recorded on a recording medium). Therefore, when the face protruding from the frame is set in the frame, the zoom is not necessarily controlled in some cases. That is, in a case the image of the face protruding from the frame is all contained in the image constituted by the effective pixels, the face can be set in the frame by moving the position of the frame in the image constituted by the effective pixels while the zoom adjustment amount is at minimum in some cases. Based on the above facts, the frame adjustment device 1c can set the face in the frame by moving the frame and/or adjusting the zoom.

(Face Detection Unit)

The face detection unit 13 is implemented when a face detection program is carried out by the CPU. In addition, the face detection unit 13 may be constituted as an exclusive chip.

The face detection unit 13 detects the face from the input image and outputs a face rectangular coordinate to the frame adjustment unit 10. At this time, the image constituted by the effective pixels is input to the face detection unit 13. The face rectangular coordinate is data showing a position or a size of the face rectangle in the input image. The face rectangle comprises the face detected in the input image.

The face detection unit 13 may detect the face by any existing method. For example, the face detection unit 13 may acquire the face rectangular coordinate by implementing template matching using a standard template corresponding to an entire face line. In addition, the face detection unit 13 may acquire the face rectangular coordinate by template matching based on components (an eye, a nose, an ear and the like) of the face. In addition, the face detection unit 13 may detect a top of a head hair by a chroma-key processing and acquire the face rectangular coordinate based on the top.

(Frame Adjustment Unit)

The frame adjustment unit 10 is implemented when a frame adjustment program is carried out by the CPU. In addition, the frame adjustment unit 10 may be constituted as an exclusive chip.

The frame adjustment unit 10 calculates a travel distance of the frame as well as performing the process which is carried out by the zoom adjustment unit 4 (that is, a calculation of the zoom adjustment amount). The frame adjustment unit 10 calculates the travel distance of the frame and/or the zoom adjustment amount.

A concrete processes of the frame adjustment unit 10 is described hereinafter. When the face protruding from the frame is entirely included in the image constituted by the effective pixels, the frame adjustment unit 10 operates so as to set the face in the frame by moving the frame.

Meanwhile, when the face protruding from the frame is not entirely included in the image constituted by the effective pixels, the frame adjustment unit 10 may carry out the same process as in the zoom adjustment unit 4 to calculate the adjustment amount of the zoom (optical zoom). However, in order to implement the above constitution, the image-taking device 1c needs to comprise the optical zoom. In addition, on a similar occasion, the frame adjustment unit 10 may calculate the travel distance of the frame and/or the adjustment amount of the zoom (digital zoom) so that the region of the face may be included in the frame as much as possible.

The frame adjustment unit 10 asks the face detection unit 13 to detect the face protruding from the frame. When the face is detected, that is, when the face rectangular coordinate is output from the face detection unit 13, the frame adjustment unit 10 calculates the travel distance of the frame based on the face rectangular coordinate. More specifically, the frame adjustment unit 10 calculates the travel distance of the frame so that the detected face rectangle may be set in the frame. At this time, when the detected face rectangle cannot be set in the frame by the movement of the frame only, the frame adjustment unit 10 calculates the adjustment amount of the zoom by the digital zoom also.

(Frame Controller)

The frame controller 11 is implemented when the program is carried out by the CPU. In addition, the frame controller 11 may be constituted as an exclusive chip.

The frame controller 11 controls the position of the frame and/or the adjustment amount of the zoom in accordance with the travel distance of the frame and/or the adjustment amount of the zoom output from the frame adjustment unit 10, that is, output from the frame adjustment device 1c.

((Operation Example))

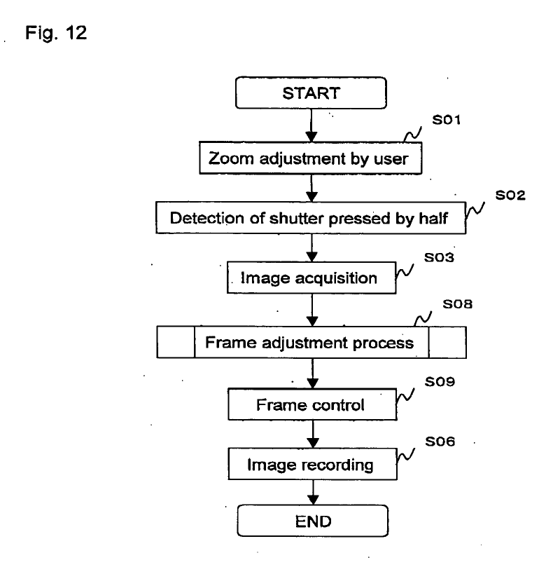

FIG. 12 shows a flowchart of processes of the image-taking device 5c. Hereinafter, a description is made of the processes of the image-taking device 5c which are different from those of the image-taking device 5a with reference to FIG. 12.

When the image is acquired in the process at step S03, the frame adjustment device 1c carries out the frame adjustment process for the image at step S08.

According to the frame adjustment process, only the process at step S15 (refer to FIG. 6) and at step S36 (refer to FIG. 8) are different from the zoom adjustment process. That is, the frame adjustment unit 10 calculates and outputs the travel distance of the frame and/or the adjustment amount of the zoom at step S15 and at step S36. At this time, the face detection unit 13 detects the face in this process. Other processes in the frame adjustment process is the same as those of the zoom adjustment process.

Thus, when the frame adjustment process is carried out at step S08, the frame controller 11 controls the position of the frame or the zoom based on the travel distance of the frame and/or the adjustment amount of the zoom output from the frame adjustment device 1c at step S09. The image acquisition unit 8 records the image acquired through a lens on the recording medium at step S06.

((Operation/Effect))

According to the image-taking device 5c, the operation in which the face protruding from the frame is set in the frame is performed not only by the control of the zoom, that is, the adjustment of the field angle, but also by the adjustment of the frame. Therefore, when the control of the frame position is performed in preference to the control of the zoom, the face protruding from the frame can be set in the frame by the control of the frame position only without controlling the zoom in some cases.

In this case, when it is determined that the face can be set in the frame only by the movement of the frame, for example, it is constituted so as to calculate only the traveling distance of the frame without calculating the adjustment amount of the zoom. When the zoom is adjusted to set the face protruding from the frame, in the frame, since the field angle is increased, the face of the object in the acquired image becomes small. Meanwhile, even when the frame position is adjusted, the face of the object in the acquired image does not become small. Therefore, it is effective that the adjustment of the frame position is performed in preference to the adjustment of the zoom, in order to acquire the intended image of the user (the image close to the image taken by the user in the state of zoom adjustment at step S01).

((Variation))

The frame adjustment unit 10 may be constituted so as to output only the travel distance of the frame without considering the adjustment of the digital zoom. In this constitution, although the face protruding from the frame cannot be set in the frame in some cases, it is effective when the image-taking device 5c is not provided with a digital zoom function. In this case, it may be constituted so as to calculate the travel distance of the frame so as to minimize the area of the flesh-colored region which protrudes from the frame, for example.

In addition, similar to the image-taking device 5b, the image-taking device 5c may be constituted so as to acquire the image (step S03) and carry out the frame adjustment process (step S08) after the process of the frame control (step S09).

In addition, the frame adjustment device 1c may be provided not only in the image-taking device 5c but also in another device. For example, it maybe applied to a minilab machine (photo-processing developing machine) which automatically developing and printing a photograph or a printing machine such as a printer. More specifically, when a range actually printed is determined from an image of a film or an image input from a memory card or the like in the minilab machine, this range may be decided by the frame adjustment device 1c. In addition, in a case where the input image is printed by an output apparatus such as a printer or the like, when the range actually outputted is determined from the input image, this range may be decided by the frame adjustment device

(Fourth Embodiment)

((System Constitution))

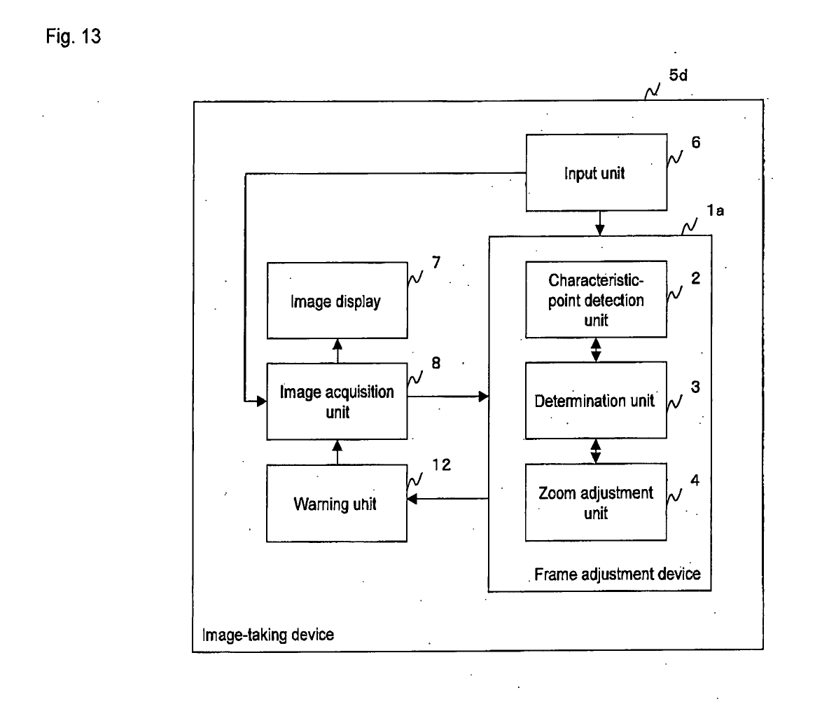

An image-taking device 5d according to a fourth embodiment of the present invention is described about a part different from the image-taking device 5a. FIG. 13 shows functional block diagram of the image-taking device 5d. The image-taking device 5d is different from the image-taking device 5a in that a warning unit 12 is provided instead of the zoom controller 9a.

(Warning Unit)

The warning unit 12 comprises a display, a speaker, a lighting apparatus and the like. When a zoom adjustment amount is output from the frame adjustment device 1a, the warning unit 12 sends the warning to the user. For example, the warning unit 12′ gives the warning by displaying a warning statement or an image showing the warning with the display. For example, the warning unit 12 gives the warning by generating a warning sound from a speaker. For example, the warning unit 12 gives the warning by lighting or blinking the light.

((Operation Example))

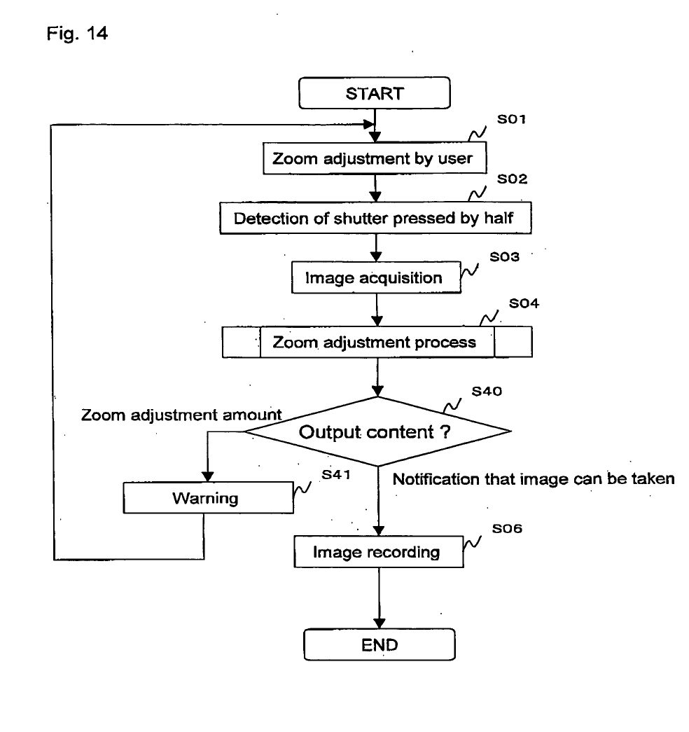

FIG. 14 shows a flowchart of processes of the image-taking device 5d. Hereinafter, a description is made of the processes of the image-taking device 5d which are different from those of the image-taking device 5a.

When the frame adjustment device 1a completes the zoom adjustment process at S04, the warning unit 12 determines whether the output content from the frame adjustment device 1a is a zoom adjustment amount or a notification that the image can be taken. When it is the zoom adjustment amount at step S40, the warning unit 12 gives the warning to the user at step S41. Then, the operation of the image-taking device 5d is returned to step S01.

Meanwhile, when the output content from the frame adjustment device 1a is the notification that the image can be taken at step S40, the warning unit 12 gives the notification to the image acquisition unit 8. When the image acquisition unit 8 receives the notification, it records the image acquired through a lens on a recording medium at step S06.

((Operation/Effect))

According to the image-taking device 5d, when it is determined that zoom adjustment is necessary by the frame adjustment device 1a, the warning unit 12 gives the warning to the user. When the face protruding from the frame disappears by adjusting the frame position or the zoom by the user, the frame adjustment device 1a outputs the notification that the image can be taken. Then, when the notification that the image can be taken is output from the frame adjustment device 1a, the warning unit 12 does not give the warning and the image acquisition unit 8 records the image.

In this constitution, it becomes unnecessary to mount a mechanism for controlling the zoom automatically, on the image-taking device 5d. Therefore, according to the image-taking device 5d, costs can be lowered, and miniaturization and low power consumption can be implemented.

((Variation))

The image-taking device 5d may be constituted so as to be provided with a frame adjustment device 1c instead of the frame adjustment device 1a. In this case, the warning unit 12 is constituted so as to give the warning when the travel distance of the frame and/or zoom adjustment amount are output. In addition, in this constitution, the image-taking device 5d may further comprise a frame controller 11, and the warning unit 12 may be constituted so as to give the warning only when the zoom adjustment amount is output. This constitution is effective when the image-taking device 5d does not comprise a zoom function.

In addition, the zoom adjustment unit 4 of the frame adjustment device 1a may be constituted so as to output a value for making the warning unit 12 carry out the warning, as the zoom adjustment amount (or warning notification), in the processes at step S15 (refer to FIG. 6) and at step S36 (refer to FIG. 8) without calculating the zoom adjustment amount.

(Fifth Embodiment)

((System Constitution))

A system constitution of an image-taking device according to a fifth embodiment is the same as those according to the first to fourth embodiments. The image-taking device to be described in the fifth embodiment functions as a video camera which can take a moving image.

((Operation Example))

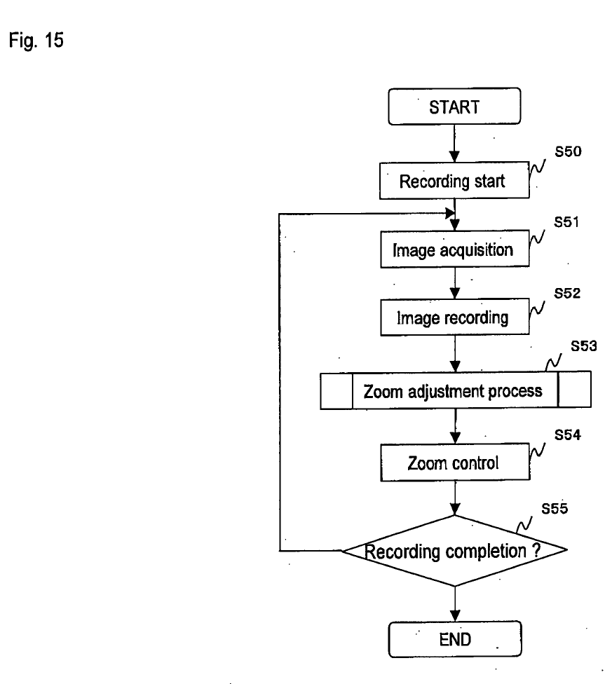

FIG. 15 shows a flowchart of processes of an image-taking device 5. The processes of the image-taking device 5 in which the moving image is taken are described with reference to FIG. 15.

First, recording is started by a user at step S50. An image acquisition unit 8 acquires an image at step S51 and records it on an image recording medium (not shown) at step S52. Then, a frame adjustment device 1 performs a zoom adjustment process from the image acquired at that time at step S53, and then controls the zoom as required at step S54. It is finally determines whether recording is completed at step S55 and when it is not (NO, S55), the operation is returned to step S51. In this loop, the image is continuously recorded as the moving image while the zoom is controlled. When the recording is completed at step S55 (YES), the operation taking the moving image is completed.

According to the present invention, the image-taking device can easily take an image in which the face of the object is set in the frame, by adjusting the frame in accordance with the frame adjustment data output from the frame adjustment device of the present invention.

1. A frame adjustment device comprising:
a characteristic-point detecting portion for detecting a characteristic point from an acquired image;
a determining portion for determining whether a face of an object protrudes from a frame of a region in which the image is acquired or not, based on the characteristic point detected by the characteristic-point detecting portion; and
a frame adjusting portion for finding frame adjustment data for adjusting the frame, based on a result made by the determining portion.

2. The frame adjustment device according to claim 1, wherein the frame adjusting portion finds the frame adjustment data including an adjustment amount of a zoom.

3. The frame adjustment device according to claim 1, wherein the frame adjusting portion finds the frame adjustment data including a travel distance of the frame.

4. The frame adjustment device according to claim 1, wherein the frame adjusting portion finds the frame adjustment data including an adjustment amount of a zoom and a travel distance of the frame.

5. The frame adjustment device according to claim 1, wherein the characteristic-point determining portion extracts a flesh-colored region from the acquired image,
the determining portion determines that the face of the object does not protrude from the frame when the flesh-colored region is not extracted by the characteristic-point detecting portion, and
the frame adjusting portion does not find the frame adjustment data when the determining portion determines that the face of the object does not protrude from the frame.

6. The frame adjustment device according to claim 5, wherein the determining portion determines that the face of the object does not protrude from the frame when there is no flesh-colored region positioned at a boundary part of the frame among the extracted flesh-colored regions.

7. The frame adjustment device according to claim 1, wherein the characteristic-point detecting portion detects a point included in each of both eyes and mouth as a characteristic point, and
the determining portion determines whether the face of the object protrudes from the frame or not, depending on whether a boundary of the frame exists in a predetermined distance from a reference point found from the characteristic point when all of the characteristic points are detected by the characteristic-point detecting portion.

8. The frame adjustment device according to claim 1, wherein the frame adjusting portion finds a plurality of frame adjustment data for setting respective faces protruding from the frame, in the frame when the acquired image includes a plurality of faces protruding from the frame, and determines frame adjustment data in which all of the protruding faces can be set in the frame as the final frame adjustment data among the plurality of frame adjustment data.

9. The frame adjustment device according to claim 2 or 4, wherein the frame adjusting portion finds a plurality of frame adjustment data for setting respective faces protruding from the frame, in the frame when the acquired image includes a plurality of faces protruding from the frame, and determines frame adjustment data in which a zoom becomes the widest angle, as the final frame adjustment data among the plurality of frame adjustment data.

10. An image-taking device comprising:
an image-taking portion for acquiring an object as image data;
a characteristic-point detecting portion for detecting a characteristic point from the image acquired by the image-taking portion;
a determining portion for determining whether a face of the object protrudes from a frame of a region in which the image is acquired, based on the characteristic point detected by the characteristic point detecting portion;
a frame adjusting portion for finding frame adjustment data for adjusting the frame, based on a result made by the determining portion; and
a frame controlling portion for controlling the frame based on the frame adjustment data found by the frame adjusting portion.

11. The image-taking device according to claim 10, wherein the characteristic point detecting portion detects a characteristic point from the image acquired by the image-taking portion again after the frame is controlled by the frame controlling portion,
the determining portion determines whether the face of the object protrudes from the frame controlled by the frame controlling portion, based on the characteristic point in the image newly acquired,
the frame adjusting portion finds frame adjustment data for adjusting the frame based on the determination made by the determining portion based on the newly acquired image, and
the frame controlling portion controls the frame again based on the frame adjustment data found based on the newly acquired image.

12. An image-taking device comprising:
an image-taking portion for acquiring an object as image data;
a characteristic-point detecting portion for detecting a characteristic point from the image acquired by the image-taking portion;
a determining portion for determining whether a face of the object protrudes from a frame of a region in which the image is acquired, based on the characteristic point detected by the characteristic-point detecting portion; and
a warning portion for giving a warning to a user when the determining portion determines that the face of the object protrudes from the frame.

13. A printer comprising:
an image-inputting portion for acquiring image data in a printing region from a film or a recording medium;
a characteristic-point detecting portion for detecting a characteristic point from the image acquired by the image-inputting portion;
a determining portion for determining whether a face of the object protrudes from a frame which becomes the printing region, based on the characteristic point detected by the characteristic-point detecting portion;
a frame adjusting portion for finding frame adjustment data for adjusting the frame, based on a result made by the determining portion, and
a printing portion for printing the frame based on the frame adjustment data found by the frame adjusting portion.

14. A frame adjusting method comprising:
a step of detecting a characteristic point from an acquired image;
a step of determining whether a face of an object protrudes from a frame which becomes a region in which the image is acquired, based on the detected characteristic point; and
a step of finding frame adjustment data for adjusting the frame, based on the result made at the determining step.

15. A frame adjusting method comprising:
a step of detecting a characteristic point from an acquired image;
a step of determining whether a face of an object protrudes from a frame which becomes a region in which the image is acquired, based on the detected characteristic point;
a step of finding frame adjustment data for adjusting the frame, based on the result made at the determining step, and
a step of controlling the frame based on the frame adjustment data.

16. A method of detecting protrusion of an object comprising:
a step of detecting a characteristic point from an acquired image; and
a step of determining whether a face of the object protrudes from a frame depending on whether a boundary of a frame of a region in which the image is acquired exist in a predetermined distance from a reference point found from the characteristic point.

17. A program for making a processing unit carry out:
a step of detecting a characteristic point from an acquired image;
a step of determining whether a face of an object protrudes from a frame which becomes a region in which the image is acquired, based on the detected characteristic point; and
a step of finding frame adjustment data for adjusting the frame, based on the result made at the determining step.

18. A program for making a processing unit carry out:
a step of detecting a characteristic point from an acquired image;
a step of determining whether a face of an object protrudes from a frame which becomes a region in which the image is acquired, based on the detected characteristic point;
a step of finding frame adjustment data for adjusting the frame, based on the result made at the determining step, and
a step of controlling the frame based on the frame adjustment data.

19. A program for making a processing unit carry out:
a step of detecting a characteristic point from an acquired image; and
a step of determining whether a face of an object protrudes from a frame depending on whether a boundary of the frame of a region in which the image is acquired exists in a predetermined distance from a reference point found from the characteristic point.
